(19) United States
(12) Patent Application Publication
(10) Pub. No.: US 2025/0173083 A1
(43) Pub. Date: May 29, 2025

(54) HUB DEVICE AND CONTROL SYSTEM

(71) Applicant: Pu-Dan Limited Corp., New Taipei City (TW)

(72) Inventor: Wei-Chih HUANG, New Taipei City (TW)

(21) Appl. No.: 18/956,254

(22) Filed: Nov. 22, 2024

(30) Foreign Application Priority Data
Nov. 23, 2023 (TW) 112145332

(51) Int. Cl. G06F 3/06

(52) U.S. Cl. CPC G06F 3/065; G06F 3/0604; G06F 3/0679

(57) ABSTRACT

A hub device including an upstream-facing port, a first downstream-facing port, a second downstream-facing port, and a control chip is provided. The upstream-facing port is coupled to a host device and receives specific data from the host device. The first downstream-facing port is coupled to a first storage device. The second downstream-facing port is coupled to a second storage device. The control chip includes a first transceiver interface, a second transceiver interface, a third transceiver interface, and a control circuit. The first transceiver interface is coupled to the upstream-facing port. The second transceiver interface is coupled to the first downstream-facing port. The third transceiver interface is coupled to the second downstream-facing port. The control circuit is coupled to the first, second, and third transceiver interfaces. In a mirror mode, the control circuit copies data in the first storage device to the second storage device or a memory.

### CROSS REFERENCE TO RELATED APPLICATIONS

This application claims priority of Taiwan Patent Application No. 112145332, filed on Nov. 23, 2023, the entirety of which is incorporated by reference herein.

### BACKGROUND OF THE INVENTION

### Field of the Invention

The present invention relates to a hub device, and, in particular, to a hub device with a data copying function.

### Description of the Related Art

Thanks to advancements in science and technology, there are more and more types of electronic devices, which offer more and more functions. In daily life, Universal Serial Bus (USB) technology has become ubiquitous. For example, mobile phones, TVs, stereos, and printers all have USB interfaces. USB flash drives are electronic products that many people carry with them. However, most notebook computers have a limited number of connection ports, and users cannot use the notebook computer's connection ports to connect all of their peripheral devices at once.

### BRIEF SUMMARY OF THE INVENTION

In accordance with an embodiment of the disclosure, a hub device comprises an upstream-facing port, a first downstream-facing port, a second downstream-facing port, and a control chip. The upstream-facing port is coupled to a host device and receives specific data from the host device. The first downstream-facing port is coupled to a first storage device. The second downstream-facing port is coupled to a second storage device. The control chip comprises a first transceiver interface, a second transceiver interface, a third transceiver interface, and a control circuit. The first transceiver interface is coupled to the upstream-facing port. The second transceiver interface is coupled to the first downstream-facing port. The third transceiver interface is coupled to the second downstream-facing port. The control circuit is coupled to the first, second, and third transceiver interfaces. In a mirror mode, the control circuit copies data in the first storage device to the second storage device or a memory.

In accordance with another embodiment of the disclosure, a control system comprises a host device, a first storage device, a second storage device, and a hub device. The host device comprises a connection port to output specific data. The hub device comprises an upstream-facing port, a first downstream-facing port, a second downstream-facing port, and a control chip. The upstream-facing port receives the specific data. The first downstream-facing port is coupled to the first storage device. The second downstream-facing port is coupled to the second storage device. The control chip comprises a first transceiver interface, a second transceiver interface, a third transceiver interface, and a control circuit. The first transceiver interface is coupled to the upstream-facing port. The second transceiver interface is coupled to the first downstream-facing port. The third transceiver interface is coupled to the second downstream-facing port. The control circuit is coupled to the first, second, and third transceiver interfaces. In a mirror mode, the control circuit copies data in the first storage device to the second storage device or a memory.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control system according to various aspects of the present disclosure.

FIG. 2A is a schematic diagram of an exemplary embodiment of a control chip according to various aspects of the present disclosure.

FIG. 2B is a schematic diagram of another exemplary embodiment of the control chip according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

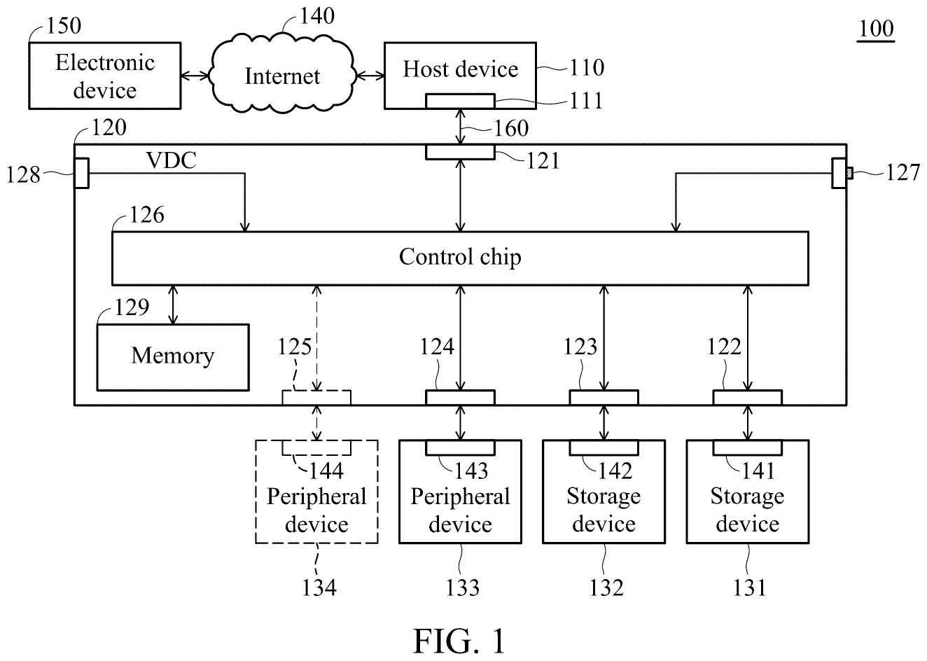

FIG. 1 is a schematic diagram of an exemplary embodiment of a control system according to various aspects of the present disclosure. The control system 100 comprises a host device 110, a hub device 120, storage devices 131 and 132, and a peripheral device 133. The host device 110 is coupled to the hub device 120. In some embodiment, the protocol of data transmission between the host device 110 and the hub device 120 is a serial transmission protocol. In one embodiment, the host device 110 comprises a connection port 111. The connection port 111 is coupled to the hub device 120. The kind of connection port 111 is not limited in the present disclosure. In one embodiment, the connection port 111 is a USB Type-C connection port, a USB Type-A connection port, a local area network (LAN) connection port, or a wireless local area network (WLAN) connection port.

Furthermore, the kind of host device 110 is not limited in the present disclosure. In one embodiment, the host device 110 is a smart phone, a desktop computer, a notebook computer, or an access point (AP). In some embodiments, the host device 110 may be coupled to the internet 140. In this case, other devices (e.g., the electronic device 150) coupled to the internet 140 can connect to the hub device 120 via the host device 110.

The hub device 120 is coupled between the host device 110 and the storage devices 131 and 132 and the peripheral device 133 to provide a communication between the host device 110, the storage devices 131 and 132, and the peripheral device 133. In some embodiments, the protocol of data transmission between the hub device 120, the storage devices 131 and 132, and the peripheral device 133 is a serial transmission protocol. In this embodiment, the hub device 120 works in one of a hub mode, a mirror mode and a debug mode.

When there is no a trigger event, the hub device 120 enters a hub mode. In the hub mode, the hub device 120 provides data from the host device 110 to at least one of the storage devices 131 and 132, and the peripheral device 133 and provides a response from one of the storage devices 131 and 132, and the peripheral device 133 to the host device 110. Taking the storage device 131 as an example, when the host device 110 points to the storage device 131, the hub device 120 provides signal from the host device 110 to the storage device 131. In this case, when the storage device 131 generates a response signal, the hub device 120 provides the response signal to the host device 110.

In another embodiment, in the hub mode, the control chip 126 of the hub device 120 distributes data from the host device 110 and writes the distributed data into the storage devices 131 and 132. For example, when a specific application of the host device 110 is activated, the user can request the control chip 126 to operate in different writing modes through the specific application.

In a first writing mode, the control chip 126 divides the specific data provided by the host device 110 into a plurality of data groups. The amount of data in one of the data groups may be the same as or different from the amount of data in another of the data groups. The number of data groups is not limited in the present disclosure. For brevity, assume that the control chip 126 divides the specific data provided by the host device 110 into a first data group, a second data group, a third data group, and a fourth data group.

The control chip 126 writes the first data group to the storage device 131 and then writes the second data group to the storage device 132. Next, the control chip 126 writes the third data group to the storage device 131 and then writes the fourth data group to the storage device 132. Since the control chip 126 stores the data groups in different storage devices in an interleaved manner, the speed of data storage can be accelerated. The number of storage devices is not limited in the present disclosure. In other embodiments, when the hub device 120 is coupled to the more storage devices, the control chip 126 writes different data groups into different storage devices.

Furthermore, although the hub device 120 is coupled to the storage devices 131 and 132, the host device 110 regards the storage devices 131 and 132 as a single storage device. When the host device 110 wants to read the specific data, the control chip 126 first reads the first data group stored in the storage device 131 and then reads the second data group stored in the storage device 132 according to an access request sent from the host device 110. Next, the control chip 126 reads the third data group stored in the storage device 131 and then reads the fourth data group stored in the storage device 132 according to the access request. The control chip 126 sequentially outputs the first to fourth data groups to the host device 110.

In another embodiment, the control chip 126 operates in a second writing mode of the hub mode according to the setting of the host device 110. In the second writing mode, the control chip 126 stores the specific data from the host device 110 in the storage devices 131 and 132 at the same time. Therefore, the storage devices 131 and 132 both store the specific data. In some embodiments, the data content of the storage device 131 is the same as the data content of the storage device 132.

The control chip 126 may use the storage device 131 as a primary storage device and the storage device 132 as a backup storage device. When the host device 110 is coupled to the hub device 120, the host device 110 only finds the storage device 131, but not the storage device 132. When the host device 110 sends an access request, the control chip 126 accesses the specific data stored in the storage device 131 and provides the specific data to the host device 110. When the specific data in the storage device 131 is damaged, the control chip 126 may copy the specific data stored in the storage device 132 to the storage device 131, thereby improving the security of the specific data.

When a trigger event occurs, the hub device 120 enters a mirror mode. In the mirror mode, the hub device 120 copies the data stored in the storage device 131 to the storage device 132 to replace the original data of the storage device 132. Therefore, the data stored in the storage devices 131 and 132 are completely the same. In this case, the storage device 132 is used as a backup device. In one embodiment, the trigger event is caused by the host device 110. For example, when a specific application of the host device 110 is activated, the host device 110 notifies the hub device 120. Therefore, the hub device 120 enters the mirror mode.

In another embodiment, the hub device 120 further comprises a button 127. In this case, when the button 127 is pressed, it indicates that a trigger event occurs. Therefore, the hub device 120 enters the mirror mode. In other embodiments, when a specific application of the peripheral device 133 is activated, it indicates that a trigger event occurs. Therefore, the hub device 120 enters the mirror mode. In this case, the trigger event is detected by the host device 110. When the host device 110 determines that the peripheral device 133 activates a specific application, the host device 110 directs the hub device 120 to enter the mirror mode. In another embodiment, the trigger event is detected by the hub device 120. When the hub device 120 determines that the peripheral device 133 activates a specific application, the hub device 120 enters the mirror mode.

Since the hub device 120 automatically copies the data from the storage device 131 to another storage device, it is possible to avoid huge losses caused by data corruption of the storage device 131. Furthermore, the copying operation is not performed by the host device 110, so it will not increase the burden of the host device 110, nor will it occupy the computing resources of the host device 110.

In some embodiments, when a debug event occurs, the hub device 120 enters a debug mode. In the debug mode, the hub device 120 determines whether the data in the storage device 131 is the same as the data in the storage device 132. When the data in the storage device 131 is different from the data in the storage device 132, it means that the data in the storage device 131 or 132 has been tampered with. Therefore, the hub device 120 sends reminder information. The type of reminder information is not limited in the present disclosure. The reminder information may be a sound information or a video information. For example, the hub device 120 may comprises a buzzer (not shown) or an image device, such as a screen or a light-emitting diode. The hub device 120 may drive the buzzer or the image device to notify the user that the data in the storage devices 131 and 132 are different. In other embodiments, the hub device 120 may issue an on-screen display (OSD) setting to request the host device 110 to display the reminder information.

The present disclosure does not limit how the hub device 120 determines whether the data in the storage device 131 is the same as the data in the storage device 132. In one embodiment, the hub device 120 checks the error correction codes (ECCs) of the storage devices 131 and 132. When the ECC of the storage device 131 does not match a first predetermined value, it means that the data in the storage device 131 has been tampered with. At this time, if the ECC of the storage device 132 matches a second predetermined value, it means that the data in the storage device 132 does not be tampered with. Therefore, the hub device 120 may copy the data in the storage device 132 to the storage device 131 to replace the data in the storage device 131. Similarly, when the ECC of the storage device 132 does not match a second predetermined value, it means that the data in the storage device 132 has been tampered with. At this time, if the ECC of the storage device 131 matches a first predetermined value, it means that the data in the storage device 131 does not be tampered with. Therefore, the hub device 120 may copy the data in the storage device 131 to the storage device 132 to replace the data in the storage device 132.

The types of storage devices 131 and 132 are not limited in the present disclosure. In one embodiment, the storage devices 131 and 132 may be a flash drive, a NAND flash memory, an external hard drive, or an SSD solid state drive. The type of storage device 131 may be the same as or different from the type of storage device 132. In some embodiments, the storage device 131 comprises a connection port 141, and the storage device 132 comprises a connection port 142. The storage device 131 is coupled to the hub device 120 via the connection port 141. The storage device 132 is coupled to the hub device 120 via the connection port 142. The types of connection ports 141 and 142 are not limited in the present disclosure. For example, at least one of the connection ports 141 and 142 may be a USB Type-A connection port, a USB Type-C connection port or a PCIe connection port. Additionally, at least one of the connection ports 141 and 142 may be a parallel transmission connection port.

The peripheral device 133 comprises a connection port 143. The peripheral device 133 is coupled to the hub device 120 via the connection port 143. In other embodiments, the control system 100 further comprises a peripheral device 134. The peripheral device 134 comprises a connection port 144. The peripheral device 134 is coupled to the hub device 120 via the connection port 144. The types of connection ports 143 and 144 are not limited in the present disclosure. For example, at least one of the connection ports 143 and 144 may be a USB Type-A connection port or a USB Type-C connection port.

The types of peripheral devices 133 and 134 are not limited in the present disclosure. In one embodiment, at least one of the peripheral devices 133 and 134 is a smart phone, a desktop computer, or a laptop. In another embodiment, the peripheral devices 133 and 134 may be home appliances, such as a television or a stereo. In other embodiments, the peripheral devices 133 and 134 are computer peripheral accessories, such as a printer, a display, a flash drive, etc.

The hub device 120 comprises an upstream-facing port 121, a downstream-facing ports 122-124 and a control chip 126. In one embodiment, the hub device 120 is a USB hub. The version of the hub device 120 is not limited in the present disclosure. The hub device 120 may have USB 2.0 version, USB 3.x version (USB 3.0, USB 3.1, USB 3.2), or USB 4.0 version or above version.

The upstream-facing port 121 is coupled to the host device 110. In this case, the type of the upstream-facing port 121 is the same as the type of the connection port 111. For example, the upstream-facing port 121 and the connection port 111 are USB Type-C connection ports or LAN connection ports.

In some embodiments, the upstream-facing port 121 may be connected to the connection port 111 via a connection line 160. The type of the connection line 160 is not limited in the present disclosure. The connection line 160 may be a USB cable or a network cable. In another embodiment, the connection port 111 plugs directly into the upstream-facing port 121. In other embodiments, the connection port 111 uses a wireless transmission technology to transmit data with the hub device 120. In this case, each of the connection port 111 and the upstream-facing port 121 has a wireless transceiver (not shown). The wireless transceiver of the connection port 111 receives the wireless signal from the upstream-facing port 121 and sends the wireless signal to the upstream-facing port 121. Similarly, the wireless transceiver of the upstream-facing port 121 receives the wireless signal from the connection port 111 and sends the wireless signal to the connection port 111.

The downstream-facing port 122 is coupled to the storage device 131. In one embodiment, the downstream-facing port 122 is coupled to the connection port 141 of the storage device 131. The type of downstream-facing port 122 is not limited in the present disclosure. In one embodiment, the type of the downstream-facing port 122 is the same as the type of the connection port 141. For example, the downstream-facing port 122 and the connection port 141 are USB Type-A connection ports, USB Type-C connection ports or PCIe connection ports.

The downstream-facing port 123 is coupled to the storage device 132. In one embodiment, the downstream-facing port 123 is coupled to the connection port 142 of the storage device 132. The type of downstream-facing port 123 is not limited in the present disclosure. In one embodiment, the type of the downstream-facing port 123 is the same as the type of the connection port 142. For example, the downstream-facing port 123 and the connection port 142 are USB Type-A connection ports, USB Type-C connection ports or PCIe connection ports.

The downstream-facing port 124 is coupled to the connection port 143 of the peripheral device 133. The number of downstream-facing ports of the hub device 120 is not limited in the present disclosure. In other embodiments, the hub device 120 further comprises a downstream-facing port 125. The downstream-facing port 125 is coupled to the connection port 144 of the peripheral device 134. Since the characteristics of the downstream-facing ports 124 and 125 are similar to the characteristics of the downstream-facing port 122, the related description is omitted here. The types of the downstream-facing ports 122-125 are not limited in the present disclosure. In one embodiment, at least one of the downstream-facing ports 122-125 is the same as or different from another of the downstream-facing ports 122-125.

The control chip 126 is coupled to the upstream-facing port 121 and the downstream-facing ports 122-125 to provide the communication between the host device 110, the storage devices 131 and 132, and the peripheral devices 133 and 134. For example, the control chip 126 may transmit the information from the upstream-facing port 121 to one of the downstream-facing ports 122-125 or transmit the information from one of the downstream-facing ports 122-125 to the upstream-facing port 121.

In other embodiments, the hub device 120 further comprises a DC jack 128. The DC jack 128 receives an external power VDC and provides the external power VDC to the control chip 126. In this case, even if the host device 110 does not be connected to the hub device 120, the hub device 120 can operate according to the external power VDC. The power source of the hub device 120 is not limited in the present disclosure. The host device 110, the DC jack 128 or the peripheral device 133 may provide power to the hub device 120.

In some embodiment, the hub device 120 further comprises a memory 129. In this case, when a trigger event occurs, the control chip 126 enters a mirror mode. In the mirror mode, the control chip 126 may copy the data stored in the storage device 131 to the memory 129 to replace the original data in the memory 129. At this time, the memory 129 stores the backup data. In another embodiment, the control chip 126 copies the data stored in the memory 129 to the storage device 131 to replace the original data in the storage device 131.

The memory 129 is independent of the control chip 126 and is located in the hub device 120 together with the control chip 126. The type of the memory 129 is not limited in the present disclosure. The memory 129 may be a non-volatile memory (NVM). For example, the memory 129 is a NAND memory. In another embodiment, the memory 129 is a magneto-resistive random-access memory (MRAM). In some embodiments, the memory 129 is a static random-access memory (SRAM). In this case, the memory 129 is disposed in the control chip 126. Additionally, the number of memories is not limited in the present disclosure. In one embodiment, the hub device 120 comprises more memories, each of which is independent. The memories may be partially independent of the control chip 126 or integrated into the control chip 126. In this case, the control chip 126 may store the data from different storage devices in different memories.

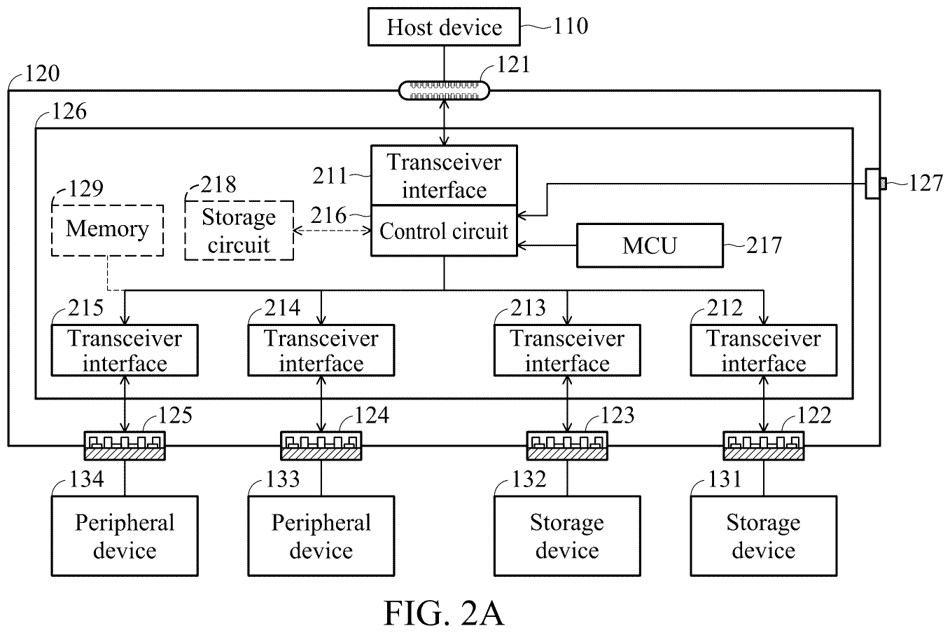

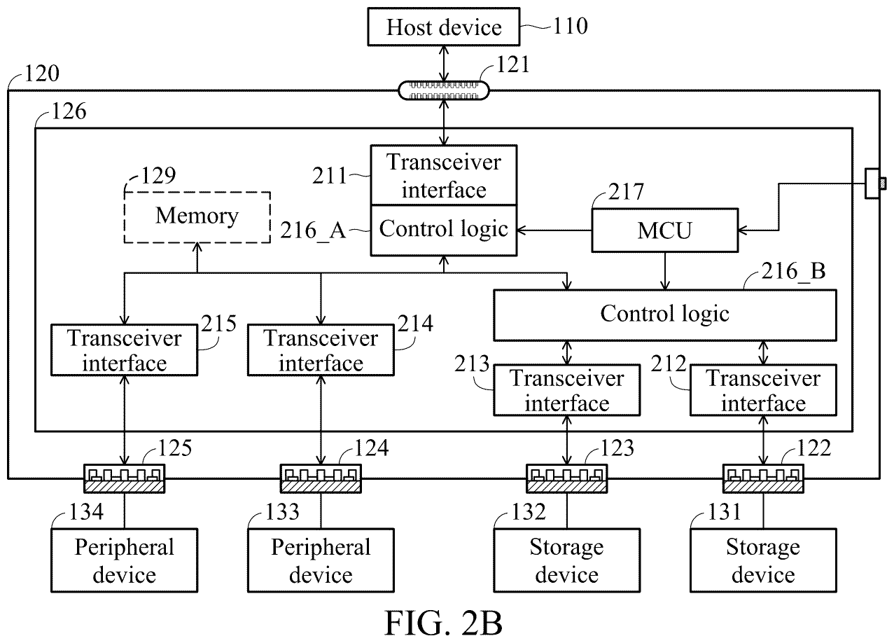

FIG. 2A is a schematic diagram of an exemplary embodiment of a control chip according to various aspects of the present disclosure. The control chip 126 comprises transceiver interfaces 211-215 and a control circuit 216. The transceiver interface 211 is coupled between the upstream-facing port 121 and the control circuit 216. The transceiver interface 211 transmits the signal from the upstream-facing port 121 to the control circuit 216 and transmits the signal from the control circuit 216 to the upstream-facing port 121. For brevity, the upstream-facing port 121 of FIG. 2A is a USB Type-C connection port. In this case, the protocol of data transmission between the transceiver interface 211 and the upstream-facing port 121 is a serial transmission protocol.

The structure of the transceiver interface 211 is not limited in the present disclosure. In one embodiment, the transceiver interface 211 comprises a USB transceiver PHY or a PCIe transceiver PHY. In this case, the transceiver interface 211 first converts the signal from the upstream-facing port 121 into a signal suitable for processing by the control circuit 216, and then provides the converted result to the control circuit 216. For example, the transceiver interface 211 converts the signal from the upstream-facing port 121 from a serial format (such as 2 bits) to a parallel format (such as 8 bits/16 bits/32 bits/64 bits), and then provides the signal in parallel format to the control circuit 216.

Additionally, the transceiver interface 211 converts the output signal of the control circuit 216 into a signal suitable for transmission by the upstream-facing port 121, and then provides the converted result to the upstream-facing port 121. For example, the transceiver interface 211 converts the signal from the control circuit 216 from a parallel format (such as 8 bits/16 bits/32 bits/64 bits) into a serial format (such as 2 bits), and then provides the signal in serial format to the upstream-facing port 121.

The transceiver interface 212 is coupled between the control circuit 216 and the downstream-facing port 122. The transceiver interface 212 transmits the output signal from the control circuit 216 to the downstream-facing port 122 and transmits the signal from the downstream-facing port 122 to the control circuit 216. In one embodiment, the protocol of data transmission between the transceiver interface 212 and the downstream-facing port 122 is a parallel transmission protocol.

The transceiver interface 213 is coupled between the control circuit 216 and the downstream-facing port 123. The transceiver interface 214 is coupled between the control circuit 216 and the downstream-facing port 124. The transceiver interface 215 is coupled between the control circuit 216 and the downstream-facing port 125. Since the characteristics of the transceiver interfaces 213-215 are similar to the characteristics of the transceiver interface 212, the related description is omitted here.

The structures of the transceiver interfaces 212-215 are not limited in the present disclosure. Since the transceiver interfaces 213-215 have the same characteristics, only the transceiver interface 212 is given as an example. In one embodiment, the transceiver interface 212 converts the output signal of the control circuit 216 into a signal suitable for transmission by the downstream-facing port 122, and then provides the converted result to the downstream-facing port 122. For example, the transceiver interface 212 converts the signal from the control circuit 216 from a parallel format (such as 8 bits/16 bits/32 bits/64 bits) into a serial format (such as 2 bits), and then provides the signal in serial format to the downstream-facing port 122.

Additionally, the transceiver interface 212 converts the signal from the downstream-facing port 122 into a signal suitable for processing by the control circuit 216, and then provides the converted result to the control circuit 216. For example, the transceiver interface 212 converts the signal from the downstream-facing port 122 from a serial format (such as 2 bits) to a parallel format (such as 8 bits/16 bits/32 bits/64 bits), and then provides the signal in parallel format to the control circuit 216.

The control circuit 216 is coupled to the transceiver interfaces 211-215 and detects whether a trigger event occurs. When there is no a trigger event, the control circuit 216 enters a hub mode so that the host device 110 communicates with the storage device 131 or 132, or the peripheral device 133 or 134. In one embodiment, when the host device 110 points to the peripheral device 133, the control circuit 216 provides the signal from the host device 110 to the transceiver interface 214 and provides the signal from the transceiver interface 214 to the host device 110. In another embodiment, when a specific application of the host device 110 is activated, the user can request the control circuit 216 to enter a first writing mode or a second writing mode through the specific application.

In the hub mode, when the control circuit 216 enters a first writing mode, the control circuit 216 distributes and stores the first specific data from the host device 110 in the storage devices 131 and 132. In the first writing mode, when the host device 110 wants to read the first specific data, the control circuit 216 reads the storage devices 131 and 132 and then provides the read result to the host device 110.

When the control circuit 216 enters the second writing mode, the control circuit 216 writes the second specific data from the host device 110 into the storage devices 131 and 132 simultaneously. Since the storage devices 131 and 132 store the same data, when the host device 110 wants to read the second specific data, the control circuit 216 reads the storage device 131 or 132 and then provides the read result to the host device 110.

In response to an occurrence of a trigger event, the control circuit 216 enters a mirror mode to copy the data in the storage device 131 to the storage device 132. In one embodiment, the control circuit 216 determines whether the button 127 is pressed. When the button 127 is pressed, it indicates that a trigger event occurs. Therefore, the control circuit 216 enters the mirror mode. In another embodiment, the control circuit 216 determines whether the host device 110 sends an acknowledgement command. In this case, when a specific application of the host device 110 is activated, the host device 110 sends the acknowledgement command. Therefore, the control circuit 216 enters a mirror mode. In some embodiments, the control circuit 216 determines whether the peripheral device 133 sends an acknowledgement command. When the peripheral device 133 sends an acknowledgement command, it means that there is a trigger event. Therefore, the control circuit 216 enters a mirror mode.

In other embodiments, in the mirror mode, the control circuit 216 may copy the data in the memory 129 to the storage device 131 or 132, or copy the data in at least one of the storage devices 131 and 132 to the memory 129. Taking the storage device 131 as an example, when a specific application of the host device 110 is activated, if the memory 129 is selected as a source device and the storage device 131 is selected as a target memory, the control circuit 216 copies the data in the memory 129 to the storage device 131 to replace the data originally stored in the storage device 131. Similarly, when the storage device 131 is selected as a source device and the memory 129 is selected as a target memory, the control circuit 216 copies the data in the storage device 131 to the memory 129 to replace the data originally stored in the memory 129.

In some embodiments, the control circuit 216 further comprises a micro-controller unit (MCU) 217. The MCU 217 stores and executes a firmware to direct the control circuit 216 to enter the corresponding mode, such as a hub mode, a mirror mode, or a debug mode. After performing the firmware, the MCU 217 may determine whether the button 127 is pressed. When the button 127 does not be pressed, the MCU 217 directs the control circuit 216 to work in a hub mode. When the button 127 is pressed, the MCU 217 directs the control circuit 216 to work in a mirror mode. When a debug event occurs, the MCU 217 directs the control circuit 216 to work in a debug mode.

In the debug mode, the control circuit 216 determines whether the data in the storage device 131 is the same as the data in the storage device 132. When the data in the storage device 131 is different from the data in the storage device 132, it means that the data in the storage device 131 or 132 has been tampered with. Therefore, the control circuit 216 sends a reminder. In one embodiment, the control circuit 216 checks the ECCs of the storage devices 131 and 132. When the ECC of the storage device 131 does not match a predetermined value, it means that the data in the storage device 131 has been tampered with. At this time, if the ECC of the storage device 132 matches a second predetermined value, it means that the data in the storage device 132 does not be tampered with. Therefore, the control circuit 216 may copy the data in the storage device 132 to the storage device 131 to replace the data in the storage device 131. Similarly, when the ECC of the storage device 132 does not match a second predetermined value, it means that the data in the storage device 132 has been tampered with. At this time, if the ECC of the storage device 131 matches a first predetermined value, it means that the data in the storage device 131 does not be tampered with. Therefore, the control circuit 216 may copy the data in the storage device 131 to the storage device 132 to replace the data in the storage device 132. In some embodiments, the MCU 217 is integrated into the control circuit 216.

In some embodiments, the control circuit 216 further comprises a storage circuit 218. When the upstream-facing port 121 receives an access command which points to the memory 129, the control circuit 216 first stores the writing data (which may be provided by the host device 110 or the electronic device 180) in the storage circuit 218. When the amount of data in the storage circuit 218 reaches a target value, the control circuit 216 writes the data in the storage circuit 218 into the memory 129. By storing external data in the storage circuit 218, the control circuit 216 does not need to frequently write data to the memory 129, so the efficiency of the control circuit 216 can be improved. In a possible embodiment, the storage circuit 218 is an SRAM.

FIG. 2B is a schematic diagram of another exemplary embodiment of the control chip according to various aspects of the present disclosure. FIG. 2B is similar to FIG. 2A witch the exception that the control circuit of FIG. 2B comprises control logics 216_A and 216_B. In one embodiment, the control logic 216_A is a USB hub control logic, the control logic 216_B is a redundant array independent disks (RAID) control logic. The MCU 217 controls the operations of the control logics 216_A and 216_B. In other embodiments, the storage circuit 218 of FIG. 2A can be applied to the control chip of FIG. 2B.

When a trigger event does not occur, the MCU 217 directs the control logic 216_A and 216_B to perform a hub operation. The control logic 216_A may provide the signal from the transceiver interface 211 to the transceiver interface 214 or 215 and provide the signal from the transceiver interface 214 or 215 to the transceiver interface 211. In another embodiment, the control logic 216_A may provide the signal from the transceiver interface 211 to the transceiver interface 212 or 213 via the control logic 216_B. For example, when the host device 110 points to the downstream-facing port 122, the control logic 216_A directs the control logic 216_B to provide the signal to the transceiver interface 212. In this case, the control logic 216_B provides the signal from the transceiver interface 212 to the control logic 216_A.

In other embodiments, the control logic 216_A directs the control logic 216_B to enter a first writing mode or a second writing mode according to the setting of the host device 110. In the first writing mode, the control logic 216_A provides the specific data from the host device 110 to the control logic 216_B. The control logic 216_B divides the specific data into a plurality of data groups and then distributes and writes the data groups into the storage devices 131 and 132. Different data groups are written to different storage devices. When the host device 110 sends an access request, the control logic 216_B reads the data groups of the storage devices 131 and 132 and provides the read result to the host device 110 via the control logic 216_A.

In the second writing mode, the control logic 216_B writes the data from the control logic 216_A to the storage devices 131 and 132 simultaneously. The control logic 216_B may use the storage device 131 as a primary storage device and use the storage device 132 as a backup storage device. When the host device 110 sends an access request, the control logic 216_B reads the storage device 131 and provides the read result to the host device 110 via the control logic 216_A. In this case, when the data in the storage device 131 is damaged, the control logic 216_B copies the data in the storage device 132 to the storage device 131 to repair the data in the storage device 131.

When a trigger event occurs, the MCU 217 uses the control logics 216_A and 216_B to copy the data in one of the storage devices 131 and 132, and the memory 129 to another of the storage devices 131 and 132, and the memory 129. For example, the MCU 217 may direct the control logic 216_B to copy the data in the storage device 131 to the storage device 132. In another embodiment, the MCU 217 may direct the control logic 216_B to read the data in the storage device 131 and provide the data in the storage device 131 to the control logic 216_A. In this case, the MCU 217 directs the control logic 216_A to copy the data in the storage device 131 to the memory 129.

Since the hub device 120 can back up the important data and store it in another storage device (such as the storage device 132) or an internal memory (such as the memory 129), it can avoid the important data from being damaged and causing huge consequences. loss. Furthermore, the hub device 120 performs data backup by itself and does not occupy the resources of the host device. For example, the central processing unit (CPU) of the host device does not need to participate in the data copying process. When data backup is not required, the hub device 120 performs a hub function and allocates data from the host device to the corresponding downstream-facing port, thereby improving the flexibility of the hub device 120.

It will be understood that when an element or layer is referred to as being “on”, “connected to” or “coupled to” another element or layer, it can be directly on, connected or coupled to the other element or layer or intervening elements or layers may be present. In contrast, when an element or layer is referred to as be “directly on”, “directly connected to” or “directly coupled to” another element or layer, there are no intervening elements or layers present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hub device, comprising:
a upstream-facing port coupled to a host device and receiving specific data from the host device;
a first downstream-facing port coupled to a first storage device;
a second downstream-facing port coupled to a second storage device; and
a control chip, comprising:
a first transceiver interface coupled to the upstream-facing port;
a second transceiver interface coupled to the first downstream-facing port;
a third transceiver interface coupled to the second downstream-facing port; and
a control circuit coupled to the first, second, and third transceiver interfaces,
wherein:
in a mirror mode, the control circuit copies data in the first storage device to the second storage device or a memory.

2. The hub device as claimed in claim 1, wherein the memory is independent of the control chip.

3. The hub device as claimed in claim 2, wherein:
the control circuit detects whether a trigger event occurs,
in response to the trigger event occurring, the control circuit enters the mirror mode,
in response to the trigger event not occurring, the control circuit enters a hub mode.

4. The hub device as claimed in claim 3, wherein the control circuit comprises:
a first control logic coupled to the first transceiver interface; and
a second control logic coupled to the first control logic, the second transceiver interface, and the third transceiver interface,
wherein:
the first control logic provides the specific data to the second control logic.

5. The hub device as claimed in claim 4, wherein the second control logic divides the specific data into a plurality of data groups, writes a first data group of the data groups to the first storage device, and writes a second data group of the data groups to the second storage device.

6. The hub device as claimed in claim 5, wherein:
the second control logic reads the first data group in the first storage device and the second data group in the second storage device according to an access request,
the second control logic provides the first and second data group to the first control logic,
the first control logic outputs the first and second data group to the host device via the first transceiver interface,
the access request is provided by the host device.

7. The hub device as claimed in claim 4, wherein the second control logic stores the specific data in the first and second storage devices simultaneously.

8. The hub device as claimed in claim 3, wherein in response to the control circuit receiving an acknowledgement command, the control circuit enters the mirror mode.

9. The hub device as claimed in claim 8, wherein the acknowledgement command is sent by the host device.

10. The hub device as claimed in claim 8, further comprising:
a third downstream-facing port coupled to a peripheral device; and
a fourth transceiver interface coupled between the third downstream-facing port and the control circuit,
wherein the acknowledgement command is sent by the peripheral device.

11. The hub device as claimed in claim 3, further comprising:
a button,
wherein:
the control circuit detects whether the button is pressed,
in response to the button being pressed, the control circuit enters the mirror mode,
in response to the button not being pressed, the control circuit enters the hub mode.

12. The hub device as claimed in claim 3, wherein:
in response to a debug event occurring, the control circuit enters a debug mode,
in the debug mode, the control circuit determines whether data in the first storage device is the same as data in the second storage device,
in response to the data in the first storage device not being the same as data in the second storage device, the control logic issues a reminder.

13. The hub device as claimed in claim 12, wherein:
the control logic determines whether an error correction code (ECC) of the first storage device matches a predetermined value,
in response to the ECC not matching the predetermined value, the control logic issues the reminder.

14. The hub device as claimed in claim 13, wherein in response to the data in the first storage device not being the same as the data in the second storage device, the control circuit copies the data in the second storage device to the first storage device.

15. The hub device as claimed in claim 1, wherein:
in the mirror mode:
in response to the host device selecting the second storage device as a target memory, the control circuit copies data in the first storage device to the second storage device,
in response to the host device selecting the memory as the target memory, the control circuit copies the data in the first storage device to the memory.

16. A control system, comprising:
a host device comprising a connection port to output specific data;
a first storage device;
a second storage device; and
a hub device comprising:
an upstream-facing port receiving the specific data;
a first downstream-facing port coupled to the first storage device;
a second downstream-facing port coupled to the second storage device; and
a control chip, comprising:
a first transceiver interface coupled to the upstream-facing port;
a second transceiver interface coupled to the first downstream-facing port;
a third transceiver interface coupled to the second downstream-facing port; and
a control circuit coupled to the first, second, and third transceiver interfaces,
wherein:
in a mirror mode, the control circuit copies data in the first storage device to the second storage device or a memory.

17. The control system as claimed in claim 16, wherein the connection port and the upstream-facing port are local area network (LAN) connection ports, and the host device is an access point and coupled to an internet.

18. The control system as claimed in claim 17, wherein the first storage device is a first flash, and the second storage device is a second flash.

19. The control system as claimed in claim 18, further comprising:
an electronic device coupled to the internet and connected to the hub device via the host device.

20. The control system as claimed in claim 19, wherein:
in response to a trigger event occurring, the control circuit enters the mirror mode,
in response to the trigger event not occurring, the control circuit enters a hub mode,
in the hub mode, the control circuit distributes the specific data to the first and second storage devices or stores the specific data in the first and second storage devices simultaneously.
